(19) United States
(12) Patent Application Publication
(10) Pub. No.: US 2006/0242084 A1
(43) Pub. Date: Oct. 26, 2006

(54) Consumer data credit or debit card

(76) Inventor: Manuel Brad Moses, Belle Harbor, NY (US)

Correspondence Address: Steven Horowitz;Counselor At Law, 295 Madison Avenue, Suite 700, New York, NY, 10017, US

(21) Appl. No.: 11/113,425

(22) Filed: Apr. 25, 2005

(51) Int. Cl. H04L 9/00

(52) U.S. Cl. 705/64; 705/65

(57) ABSTRACT

A consumer data credit card or debit card or personal computer wallet linked to an Internet master catalogue of products. The consumer data card empowers the small credit card or debit cardholder against retailers, by mining and analyzing their consumer profile data, for anticipated purchases, and then leveraging the consumer's offers on specific products, for group discounts. It uses a new business method for pooling, options, and brokering dispersals of consumer's offers to retailers; via the Internet for price discounts. The consumer's card is encrypted as an origin code, for privacy, of their personal consumer profile data being dispersed. The master catalogue is linked via the Internet to remote computer display kiosks, at shopping and information stations, allowing for in-store display of discounts; geared to specific cardholders, and to facilitate in store shopping and checkout; by the personal computer wallet and allowing worldwide virtual shopping.

### CROSS REFERENCE TO RELATED APPLICATIONS

| | | |
|---|---|---|
| 6834271 | November, 1999 | Hodgson 705/72 |
| 6755342 | December, 2001 | Jordan 235/380 |
| 6611881 | August, 2003 | Gottfurcht, et al. 710/18 |
| D444465 | September, 2000 | Do D14/341 |
| 6179209 | January, 2001 | Goodwin 235/486 |
| 5973756 | October, 1999 | Erlin 348/734 |
| 5956699 | September, 1999 | Wong, et al. 705/39 |
| 5950179 | September, 1999 | Buchanan, et al. 705/38 |
| 5729591 | March, 1998 | Bailey 455/558 |
| 5550897 | August, 1996 | Seiderman 455/588 |
| 5920926 | May, 1995 | Low 705/74 |
| 5317636 | May, 1994 | Vizcaino 705/65 |
| 5259649 | November, 1993 | Shomron 283/114 |
| 5220593 | June, 1993 | Zicker, et al. 455/407 |
| 5134773 | August, 1992 | LeMarie, et al. 29/827 |
| 5101200 | March, 1992 | Swett 340/937 |
| 4868900 | September, 1984 | McGuire 235/380 |
| 4667087 | May, 1987 | Quintana 235/380 |
| 4004133 | January, 1977 | Hannan, et al. 235/441 |
| 6330543 | December, 2001 | Kepecs705/14 |
| 6311169 | October, 2001 | Duhon 705/38 |
| 20050065875 | Mar., 24, 2005 | Beard |
| 20040238622 | Dec., 2, 2004 | Freiberg |
| 20040232226 | Nov., 25, 2004 | Jordan |
| 20040007618 | Jan., 15, 2004 | Oram |
| 20030200170 | October, 2003 | Tenembaum |
| 20020128034 | September, 2002 | Stratmoen and Stone |
| 20020123972 | September, 2002 | Hodgson, et. al. |
| 20020116330 | August, 2002 | Hed, et al. |
| 20010034717 | October, 2001 | Whiteworth |
| 5789732 | Aug., 4, 1998 | McMahon, et al. |
| 5649114 | July 1997 | Deaton et al. |
| 6516302 | February, 2003 | Deaton et al. |
| 2002/0116212 | August, 2002 | Shaw et al. |
| 2002/0169661 | November, 2002 | Demesky et al. |
| 2003/0101102 | May, 2003 | Kim |
| 6611881 | August, 2003 | Gottfurcht, et al. |
| 6738901 | May 2004 | Boyles, et al. |

### STATEMENT REGARDING FEDERALLY SPONSORED RESEARCH OR DEVELOPMENT

Not Applicable

### BACKGROUND OF THE INVENTION

The field of endeavor to which my claims pertain, are the credit card processing and banking industry and its associated detrimental effects on the consumer. Of course—it is true that discount web sites exist, that allow for bidding on prices and it is true that there are credit cards having multiple rewards. These are general business methodologies long existing in the history of bargaining, haggling, and in advertising. For credit cards, it is competition for market share that is driving direct money back rewards, for example, providing a discount of 5% money back on all purchases.

The prior art—I do make mention of—relates to the specific technology of credit cards, electronic wallets, and e-commerce as they are used on the Internet. This idea is highly distinguished from any that exists and represents an insightful, non-stereotypical view of Internet discount shopping. Some other patents reference ideas dealing with bulk sales and associated discounts rarely through the Internet, but they are highly different in their methods, from those I claim and described here.

Consumers require more than simple rewards or discount web sites. Consumers require a consumer data card that is a guardian of the consumer. As an attorney who practices in this area I recognize that the regulations of the industry are such that they favor the bank. Such regulations include the conservative Supreme Court ruling of Smiley vs. Citibank (S.D.), N.A. 517 U.S. 735 (1996). This case permits the Comptroller of the Currency to set interest rates that banks can charge, even if those laws may be considered to be usurious in many states.

The credit card industry—like any corporation—is more interested in the bottom line than in the average consumer—always seeking to maximize profits. Recently appearing on the Public Broadcasting Show “Frontline,” Senator Christopher J. Dodd of Connecticut, has warned the banking lobby to be careful of their aggressive activity, lest a populist back lash resulting in harsh legislation being passed to protect the consumer against high interest rates and minimum payments that can take years to complete.

This consumer data credit card does not wait for that to occur. It is a present day solution that goes beyond simple interest repayment to empower the consumer, as never before. The American pocketbook cries out for a credit card to be their guardian and to take on the big retailers!

The average consumer has no advocate to really leverage spending data against large corporate retailers. There is no business methodology to help them do this.

It is important that we take a new look at consumer data. Why? Credit card processing is a good and necessary part of our lives—making credit convenient and instant. There is an enormous amount of data that is daily complied on all our credit transactions, through the main credit reporting agencies, Transunion, Experian, and Equafax. This takes place while the cardholder is largely unaware of just who has access to their personal data. That personal data is their valuable commodity of which they receive no fair benefit—but lies naked to many.

The greatest benefit the consumer gets out of their data being processed and traded—is fraud protection. More needs to be done with this data. There is a new revolution going on right under our noses that is driven by the Internet: it's a content driven revolution. It is an information revolution. It is a revolution that puts an information weapon into the hands of the American people. But they have not learned hot to take hold of it to make the best use of this new weapon for individual consumer discounts!

If we can look to the foundation for the analogy to the new business method patent I propose; it would be found in the original Sears and Roebuck Catalogue. This was a universal catalogue of products that was available in mail order form.

Today the Internet is that same old catalogue, but more diverse, containing many more products and far more exciting. But no one has taken the idea of online buying and linked it to a credit card making use of consumer data in a comprehensive way that teams up consumers against retailers for discounts. Data and their spending power is the only real thing that consumers have of value to leverage, against the large retailers. No one has taken the time to analyze their anticipated purchases, and to broker this group data directly to retailers through a computer program of a master on-line catalogue.

While data mining is taking place, it is generally not for the benefit of the individual cardholder, but is related to mailing lists, and demographic target markets for advertising; merely an invitation to deal. This is no more than is common to the Internet or mass-market mailings. This is far from the explosive potential data mining represents that would empower the lone ordinary consumer to speak directly to the teeth of power: large corporate manufacturers. Here they do not face the tiger alone.

Now imagine billions upon billions of consumer transactions, as a language. A language that can predict the purchases the consumer will buy or their credit worthiness, their demographics and the specialty goods they desire. Imagine a credit card that teaches the consumer how to speak this language directly to product suppliers; making them compete for this business. How important is marketing information to the large corporation today to drive sales? How important are confirmed hot leads to the survival of a business? It is everything. Those leads come from the consumer data card in the business methodology to be described.

### BRIEF SUMMARY OF THE INVENTION

What is the electronic wallet of the future? It is technology we can achieve today. It is not nearly as important in its external fashionable appearance, as its internal beneficial consumer function. The electronic wallet of the future is a credit card or debit card, which is described here as a consumer data card.

The consumer data card contains a history of all the consumer's spending habits: past, present, and that anticipated for the future. We then take their individualized consumer profile and create a far more detailed system of classification, for their spending habits; determining their potential or anticipated purchases.

We classify a universe of products in an Internet master catalogue: everything they spend money on—gas station, insurance, supermarkets, loans, retail products (“Hot Brands” and “Best Buys”), utilities, and service providers.

Within this business method we update and embed their anticipated purchases into the system of product code identifiers. Including highly specific offers on existing products, as may be found in the Best Buys section and Hot Brands section of our on-line catalogue. Then we take those offers and pool them for discounts or options to buy. This is known as creating an open pool: which invites additional offers. We leverage their data against the big product suppliers for discounts. We become a guardian of the consumer. We start a revolution.

We have special rewards that cannot be achieved by ordinary credit cards, merely from a good merchant relationship, as can be found with American Express. Origin Nation goes far beyond that, with group discounts to the individual so that all purchases: the cardholder's use of the card for all things they spend money on, become their own rewards—far more profound—in direct pricing for highly specified offers for products below retail sales prices. This is something other major credit cards cannot do. A system methodology of the consumer data card proposed herein can.

We create a new credit card instrument having long-term beneficial use for the average consumer. Instead of a windfall for banks, we create a win-win situation for consumer and product supplier. We save the consumer money and drive retail sales, in a saving, which can also be realized by business card holders. The consumer data credit card creates a long term, more responsible use, for credit cards in a largely unregulated banking industry.

### BRIEF DESCRIPTION OF SEVERAL VIEWS OF THE INVENTION

FIG. 1—Construction of the master catalogue on the Internet, to house a universe of products, goods, and services; it must contain the appropriate computer based language; laying the foundation for all the features described in this patent and be accessible on any home personal computer.

FIG. 2—The central data processing facility for associated software and hardware: must be able to handle a high volume of global Internet traffic, from both personal computer users, and for high volume incoming data streams, and large outgoing data dispersals. It should also function to analyze incoming data, and route outgoing data of all products, goods, and services, offers, counteroffers, and acceptances.

FIG. 3—Consumer card acceptance is unlike an ordinary consumer credit card acceptance implying an in person customer orientation to explain all the functions of the card and Internet master catalogue usage.

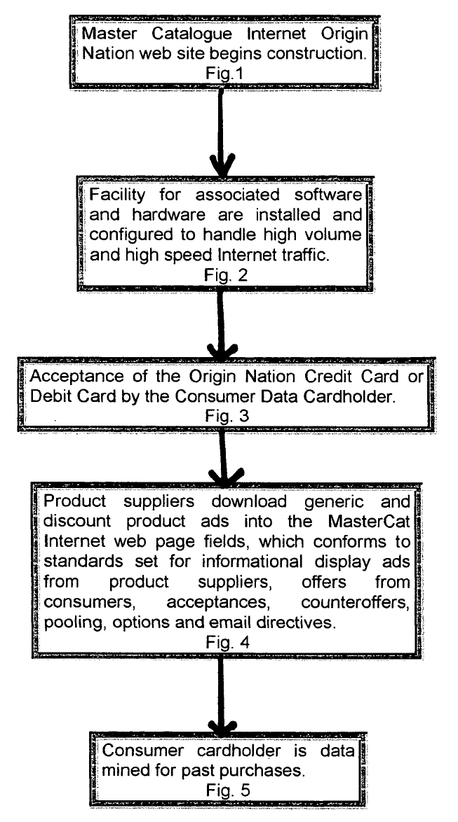

FIG. 4—Product suppliers download their product data into flexible fields of web pages on the Internet; with the cleaning, cutting, editing, sizing, and final arrangement of catalogue done by consumer data processing center conforming to the anticipated catalogue usage, for all required fields and catalogue sections.

FIG. 5—Data mining of the consumer for creating a standard profile of repetitive use products, and repeated point of sale merchant visits. Profile is adapted for use in the “My Discounts,” section of the catalogue.

FIG. 6—Creation of the Origin Code: permanent origin code encryption of the consumer profile; allowing the consumer data to be dispersed without revealing the consumer's actual identity. The consumer Origin Code is housed in the central data processing center. All information filtered about the consumer and sent over the Internet is linked to this in-house code. This is the access code to the consumer's home page. It is only entered one time on the home page—then a secure access link is remembered by the computer that blocks the actual code from being revealed ever again. In data dispersals this Origin Code is randomized with a return link to the actual code in the central data processing center.

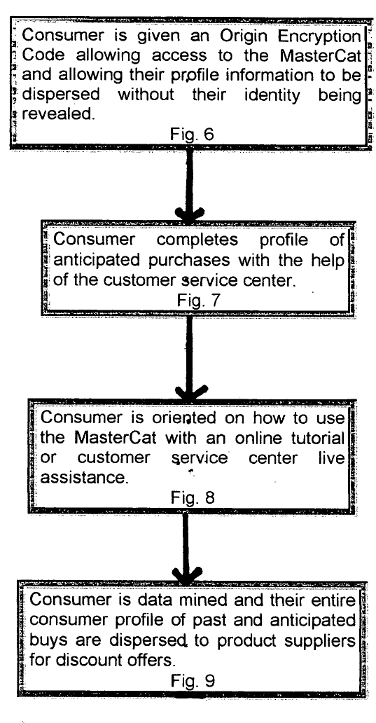

FIG. 7—Consumer completes data profile survey on line or initially via a customer service representative interviewer who enters the data for them in their Internet survey form.

FIG. 8—Consumer is oriented with a downloadable streaming video display on how to use the master catalogue or simple on line set by step click on tutorial.

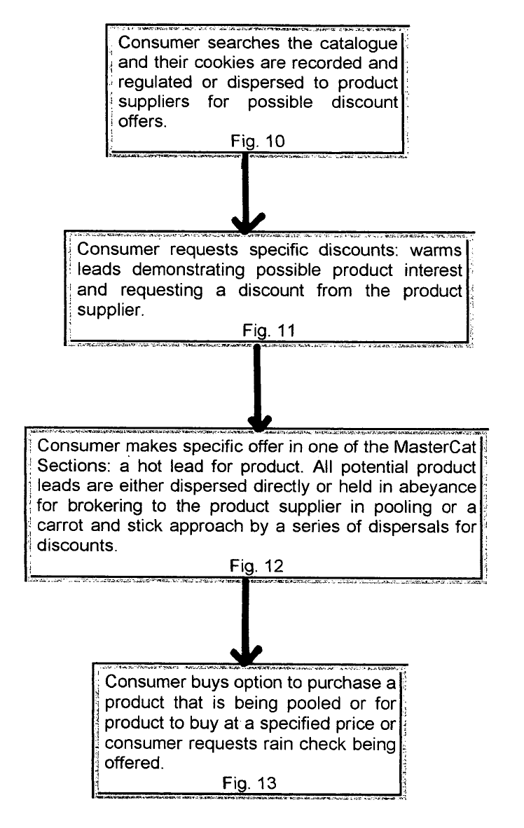

FIG. 9—The consumer profile is data mined for anticipated purchases—per the survey—and the updated data mined profile is activated.

FIG. 10—Consumer's search of the master catalogue and other Internet based product searches are recorded, for data profile updating, and this information is dispersed to specific product suppliers, so that new discount offers in the “My Discounts,” section of the Internet master catalogue are regularly updated.

FIG. 11—The consumer is able to click on a link or product to demonstrate a warm lead; requesting a discount from the product supplier, allowing updating of the “My Discounts,” section of the Internet master catalogue.

FIG. 12—All hot leads are analyzed by the consumer data processing center before being dispersed to the product supplier, for potential pooling or brokering to achieve maximum discounts.

FIG. 13—Options are available for various posted prices and are generally associated with pools. Rain checks are by displayed openly on the Internet or by direct request to the manufacturer from the consumer card holder and generally have a shorter life expectancy than an option. A system for posting options and rain check requests must be either open to the entire master catalogue or associated product supplier via a data dispersal or direct master catalogue link or be totally processed as opaque to the master catalogue and come in directly to the data processing center for dispersal notification via email.

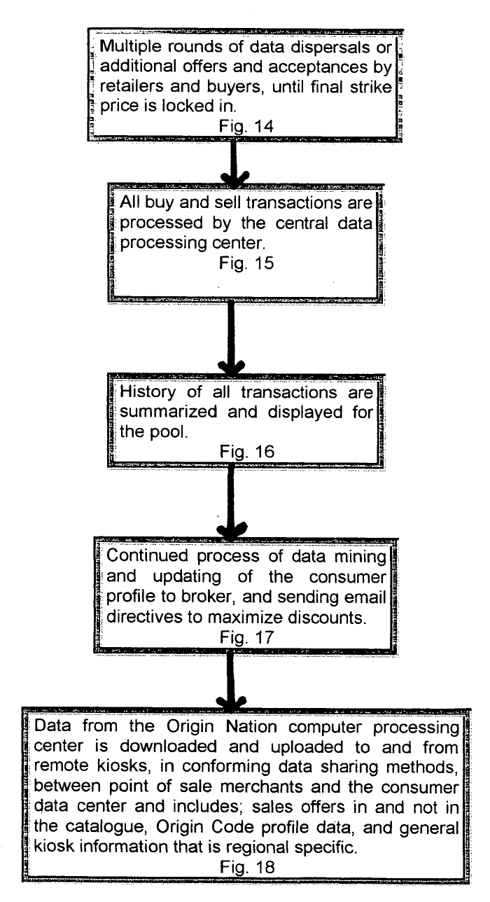

FIG. 14—Multiple data dispersals are product supplier specific. This means that the product supplier has to have a data receiving center for processing multiple offers. This strongly implies—they are a large chain store or large manufacturer. If the product supplier is not equipped to process the data then this can be accomplished by their general posting of a counter offer or through their assigned personal computer agent and our central data processing center. The product supplier can also set guidelines for counteroffers to be accepted, and the central data processing system can process all acceptances or counter offers on their behalf following those established guidelines.

FIG. 15—All buy and sell transactions are processed either by the central data processing center or the regular credit card processing entity.

FIG. 16—This figures requires a graphic illustration that would in summary chart the history of the transaction. A separate section can exist for this purpose, of such summaries, and further summaries can be so illustrated in a further combined form. This would provide general indicators for pooling in certain important sectors such as: automobiles, computers, and insurance products.

FIG. 17—Continued processing of all incoming data on consumers; taken from multiple, internally generated sources, and outside sources, including the full spectrum of associated demographics; not merely individual specific—but relevant to creating the consumer's regional profile. This data mining is also in reverse, and global in reach, of product suppliers, for invitation into the system for their products or upcoming products and their associated sales statistics. We also use a system of email alerts for product discounts, and information on making product offers as pool participants and other important information from the central data processing center, which goes directly to the consumer.

FIG. 18—Data from kiosks is always coming in from site specific regions; data is continually going out to those remote computer terminals. This kiosk information is sectioned off into a specific section of the Internet master catalogue. This data includes high content graphic information. All data is processed through the central data processing system—although in some cases certain data from the kiosk may not be processed from the kiosk into the open master catalogue—by agreement—to get the credit card holder to go to the store for their specific discounts not displayed on the master catalogue.

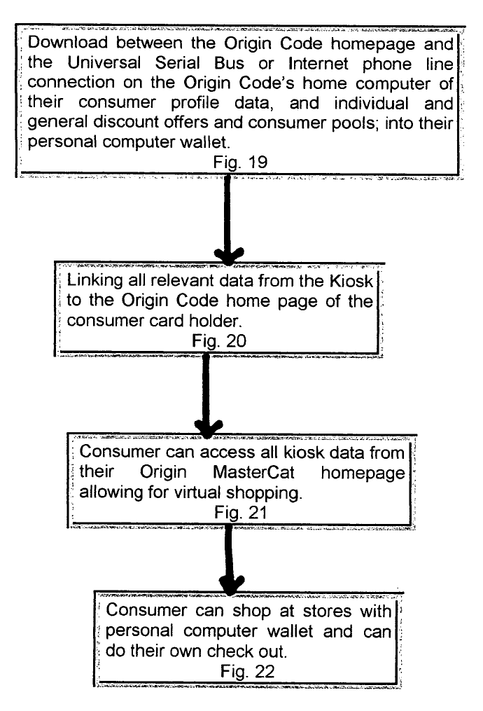

FIG. 19—There has to be a link between the personal computer and the personal computer wallet. Generally, that link will be via the universal serial bus of the personal computer, but can be through the high speed or internet phone connection. This will allow for rapid data transfer into the personal computer wallet. Allowing for the preconfigured sorting functions of the wallet to be activated; this pre-configuration will also come through the master catalogue itself; sorting shopping lists and displaying their discounts for requested stores to aid the shopper.

FIG. 20—This kiosk data needs to be sorted for relevancy. The consumer card holder should be able to accomplish all the search functions, when at the kiosk as they can accomplish, when searching the master catalogue on their personal computer.

FIG. 21—Linking all data from the kiosk has an ultimate goal: allowing for virtual shopping and walking the consumer down the isles to a specific product, and examining that product, as if in the actual three dimensional store. Initially this will be only in two dimensions on a computer screen and over the Internet or without an actual virtual walk through to the product—at all—but still containing much relevant store or regional shopping information to aid the consumer in planning their shopping, events or vacation trips.

FIG. 22—Consumer is able to deactivate the electronic product tags on products. It starts by activating a pin code in the personal computer wallet. Now products which are deactivated are also transacted as buys, and recorded into the personal computer wallet as an LCD paid receipt. Now the consumer can exit the store with deactivated products; allowing their LCD display to be examined by security. Instead of a product tag deactivation the personal computer wallet can include a bar code scanning capability, and the LCD display would likewise be activated recording sells for security to examine at the in-store exit.

### DETAILED DESCRIPTION OF THE INVENTION

We begin the creation of an Internet Master Catalogue web site known as the “MasterCat.” It is a master catalogue of retail products, goods, and services: (product suppliers.) These were product suppliers who have agreed to be a part of our catalogue. At first they will be large retail chain stores, large corporate manufacturers, and a plethora of other certified product suppliers who meet our criteria for quality, return policies, and method for handling consumer disputes.

The MasterCat is broken down into the following main sections: “Best Buys,” “Hot Brands,” “Pools,” “Competitive Bids,” “My Discounts,” and “General Product Catalogue.” The Best Buys section contains rated product information compiling products that generally cost over 100 dollars and typically cost over 500 dollars. They are rated products with associated product information not usually found in the other parts of the catalogue. They are open for large scale offers from consumers in the form of pools.

The Hot Brands are just that. This section contains brands that are popular in the marketplace, and ones that are open to potential pooling others that are not but are discounted.

The Competitive Bid section is the section conducive to products like, supermarkets, gas service stations, insurance products or loan differing loan interest rates, individual and group travel, online entertainment—although any product supplier can be in this section. It is a section that pits one product supplier against another and is conducive to pooling of consumer offers.

The MasterCat can be searched by the consumer cardholder from their “Origin Code” homepage and the following click on links: to product categories and the associated stores carrying the product; a link to the specific chain store, a specific store or a specific product in the store or advertisement. The search can also be by classification of product types. The search can also be by key word search or MasterCat product code search. Each section can be searched individually searched as the general catalogue.

The Internet profile data of anticipated or past consumer surveys results in solicitations from the product supplier for discounts—especially when an anticipated buy: this is a fill, if the profile has no anticipated purchase survey loaded: this is a gap in the consumer profile. To access posted discounts in the catalogue you need not have even completed a survey. The survey is only a function to cultivate direct offers from product suppliers. It is a way the consumer has to control solicitations and special offers for a consumer hot lead and a method for the data processing center to determine hot leads for data dispersals and the creation of open pools.

Gap and fill information can be displayed in graphic easy to read displays or in highly specific terms associated with specific product(s) the consumer desires to buy. You can open a catalogue and see if such a product is “loaded” for your profile as an anticipated buy. The consumer can wipe their profile and store it for later restoration. The consumer can update and change their profile. The consumer can wipe parts of their profile or restore parts. You can delete parts of your profile permanently or in the alternative only with permission of the central data processing center. For example, you cannot delete data of your past buys, but you can delete the ability to have future dispersals based on data mining of your past buys or anticipated buy, which completely stops unwanted ads.

The consumer can also control solicitations more quickly and easily by a simple general category switch for on and off, which controls their incoming ads. The consumer can also stop all solicitations—at once. The consumer is given the option of controlling not only the number but the quality of solicitations they receive: number in the specificity of the products they desire solicitations on; executed by simply clicking on broad product category(s) or a general store chain logo or brand(s) or specific products or the associated icons or express representation of the product itself.

The consumer can control the quality of the ads it receives: related to content and form. Primary examples include—streaming video, pop up ads, broad window display encompassing reduced or wide screen angles of viewing, amplification of product or if the retailer downloaded appropriate content in the ad the consumer can control various multilevel views or 360, degree views of the product, split or multiple screen viewing, informational crawls, enhanced virtual shopping through remote computer in store display kiosks and all the associated benefits of the Internet content driven revolution.

In the alternative the data processing center regulates the quality and content of all ads. All information downloaded into the MasterCat is thoroughly scoured for viruses, and must conform to standards set for the MasterCat to prevent hacking and computer viruses being spread to consumer Internet surfers.

The incoming email of the consumer shall be closely regulated. We will never give out the email address of the consumer—least we risk spam and loose credibility. All email messages will be regulated through the MasterCat homepage. Only in very limited circumstances will data dispersals go directly into the inbox of the consumer, for example, a reminder of a high dollar value offer, and subsequent notification of a counter offer from the product supplier. In the alternative to simplify correspondence emails can be direct from product supplier to consumer—especially for time sensitive pools—and high-ticket value items, when the consumer has direct questions to the product supplier

The main methods for posting ads in the Internet MasterCat include: downloading directly from the product supplier an ad catalogue web page, which can be formatted as follows: a store link, a product link in the store, a product icon link, a data stream link of the product (for video ad display), a display window of the product, which includes product description or a page of associated product icons in the store category other means of display are flexible for artistic reasons and for reasons of efficient organization of icons and quick viewing products.

The ads from product suppliers must be able to incorporate a field for posting data related to creating a consumer offer pool: (price offered), and posting counter offer (from product supplier), time limit for the pool, and final strike price, and associated overall statistics for the transaction. The ads should incorporate an email message link for directives from the central data processing center on recommended offers for cardholders and other pooling directives. The ads should incorporate an email link, directly from the central data processing center to the product supplier for related pool information and brokering consumer data. So it will be important to have dedicated management in the product supply pools with decision making power able to respond—in almost real time.

The consumer can also allow us to track their Internet cookies for continued data mining and solicitations. The consumer can allow store web pages to individually track their cookies and products they view, when they visit their store web page. In the alternative the consumer can turn off all cookies or allow cookies for one or more products. The cookies become a part of the mined consumer data profile. It is an easy control mechanism on the consumer's home page of the MasterCat, but can be simply activated anywhere in the catalogue for a product or products.

There needs to be a series of internet servers and associated routing for transferring real time, high quantity data, into the central, data processing center, and for dispersing real time, high quantity data, out to retailers and cardholders or large scale, credit card processing company who processes the actual buy sells. All systems of all computers in the central data processing center should be protected against, hackers, and viruses. Its dedicated lines should be multiple and secure for data transmission and the data processing system should have multiple back ups to prevent crashing or a system data overload.

Once the catalogue system is in place, we are able to begin the process of establishing consumer data credit cardholders. It starts with the credit card acceptance, an understanding between the card servicing data center and the consumer. It is an alliance with the consumer: we create a consumer profile of their spending habits, past, present, and those anticipated for the future.

Initially the consumer completes an online questionnaire or in person or telephone interview conducted by a customer service representative that will last about 20 minutes to complete. This questionnaire includes information about where they regularly shop, what are the product brands they regularly buy, and what are their anticipated purchases for big-ticket items in the coming year. We also ask them to supply us with information on all the rest of their periodic bills, examples of which include: insurance, mortgage, loans, utilities, movies, Internet service, and more.

Now the credit cardholder is assigned an “Origin Code.” This is defined as the true code known only to the consumer and the data processing center: it is the consumer's identity for use when they search the Internet master catalogue of products goods and services (product suppliers.) At all times the circulated identity of the consumer or their “Origin Code,” is seen by all other parties during E-commerce web page viewing or email communication—as an encryption.

This encryption of consumer profile data allows the consumer to feel comfortable about revealing their consumer profile data of anticipated and past purchases to all relevant product suppliers. The consumer remains unknown until they accept an offer. Hence we call the card, “Origin Nation:” a card global in character comprising millions of Origin Codes or cardholders from many nations. It should be noted that the term, “Origin Nation” is an aesthetic term of art, not a technical term of art, and may be any name designated by the central data processing entity or organization which controls, analyzes, and disburses the consumer data.

The Origin Code is the code a cardholder enters to allow entry into their personalized online Internet master catalogue or “MasterCat.” It can be a personalized with the name a consumer chooses or one with alphanumeric meaning for routing, collecting, and processing the individual consumer's data. When they do accept an offer—only one specific part of the cardholder's profile is revealed—never their master Origin Code or true identity: this is the personal code allowing the individual access to the computer MasterCat. This is a feature that is highly desirable; one need only look at the popularity of “Spyware,” “Firewalls,” and “Virus Scans,” which prevent unwanted intrusions.

Now the consumer has access to their online catalogue. The first step is to orient them to the catalogue with a tutorial or with access to a telephone customer service representative who can also answer their questions on how to update their consumer profile for anticipated purchases, and walk them through the Internet MasterCat and its associated functions.

We help the consumer to build their consumer data profile: consisting of past and anticipated purchases. It is a means of gaining more detailed information building in specifics on information gleaned from the in-person or telephone survey. The online questionnaire is based on product categories, where they shop, and what they anticipate to buy in the near or distant future or for those who it suites best; the survey is simply completed by a 20, minute telephone interview that is keyed into the Origin Code profile of the consumer cardholder.

The Internet online questionnaire is also keyed into the consumer data cardholder's consumer profile. And we regularly ask for updates of the consumer profile for specific categories or in total. An important part of the questionnaire asks about the consumer's present possessions or planned big ticket spending items: for example, age of car(s), household furnishings, planned vacations: including information about anticipated date of departure and return for competitive charters or anything they anticipate spending money on, including health and life insurance.

Now the consumer's MasterCat Internet catalogue is activated; they begin the process of receiving solicitations and searching the catalogue. We track their cookies. We also begin the process of advising them by an email welcome of how email directives work to their benefit, when pooling their offers with others and searching and using the MasterCat. The email directives come into their message center on the home page of the catalogue and directly into the product pool web page, so that they can simply and quickly get real time information on the pool (this is particularly important if it is a short term, fast moving pool), when for example, there is a limited supply of a “Hot Brand” product.

Email directives are posted directly to the Origin Codes in their inbox or on the web page pool: for example, a recommended price for initial offers is displayed. This is determined by the total number of anticipated purchases that will come in based on data mining, surveys, past sales or after consultation with the product supplier. Now a pool is established wherein data is collected for a series of dispersals to the product supplier; to leverage and broker incentive—in a carrot and stick approach—to achieve the lowest possible price for all people in the pool.

There are three types of leads that can come in to the data center, as offers from cardholders: 1. Hot lead: defined as a confirmed lead to purchase at a specific discount price. 2. Warm lead: defined as a potential offer below the recommended price or a desire for a rain check at the recommended price (if a rain check is being offered.) Both of these leads can be brokered to the product supplier. 3. Option to buy: if no rain check exists this option can be at any stated price and, of course, have an associated cost. Lowest priced option is the initial, first round, recommended price offer. Most expensive, any option at or below the strike price: defined as the final price for all accepted offers for the entire pool. These options expire after a specified period of time and may be transferable or in the alternative non-transferable depending upon custom and use and how it effects the competitive health of the general market processes.

Here is an alternative, streamlined example achieving the stated goal—for an “Open Pool:” all product leads would come in without any restrictions or guidelines and be dispersed to the product supplier either directly or in a series of dispersals from the consumer data center—to broker—for the lowest possible strike price. The inauguration of an open pool may include recommended price offers from the central consumer data processing center or no recommendations whatsoever such as for a hot brand with a limited supply.

Counter offers or acceptances can come from the merchant directly to each cardholder or through the consumer data system or in open price posting counter offer on the Internet or in the alternative come through the cardholder data processing center via email posting to the Origin Code or posted in the Origin MasterCat product page as a more direct method. All postings and counter offers can be accomplished with the same methodology for open and regulated pools. This way the lower the offer for the pool is data the product supplier can see as confirmed firm leads and to speed up the process of confirmed hot leads—lower the price—of their own initiative. These series of offers and counter offers can go through one or several rounds with all participants in the pool benefiting equally or differentially at stated levels of confirmed acceptance. Probably an equal beneficial strike price will prove the best long term business methodology for achieving initial strong interest, as opposed to a wait and see how low it goes approach. This will reveal more about the actual nature of the market of potential buys for all concerned.

In a freer approach, pool creation may be accomplished by the data cardholders themselves, if set for a specific click on the product itself or check box interest in the appropriate section that the product be pooled. Then the offer criteria can be entered in a simplified form that requires the consumer cardholder to enter a firm price offer to buy at a specified price. As appropriate we can also form chat rooms for discussion of patrons looking for other members to form a pool. For such a process we may issue general guidelines at for example, 10-20 percent below the retail price. We will not sell options until a pool is established. All pooling requires the participation from the retailer. Options are fees shared with the product supplier or in the alternative not shared: retailer takes all or consumer data center takes all or part.

Under the pool creation data can be sent directly to the product supplier or be brokered through the consumer data processing center. Probably the more expensive items will require more brokering and more rounds to achieve the best price. Of course this is also largely determined by the marketplace and existing demand: seasonal air travel and chartered flights versus a new model of car versus a newly released movie.

The “My Discounts Section:’ are those specific offers from product suppliers that are geared to the data profile of the individual cardholder: the results of data mining, surveys, and telephone interviews. They provide incentive for the consumer to regularly update their profile. Pools from various products can be in this or any other section of the catalogue. Pools as a separately organized section can be assembled and searched by the consumer cardholder.

The “General Sections,” of the catalogue can include discounted and non-discounted products. All products have to potential to be probed for discounts by individual request to the manufacturer or by pool formation.

The “Consumer to Consumer” sections of the catalogue are a form of used furniture classified. It allows the—consumer to consumer—communication to take place, for any product, good or service that you can find in the classifieds. As in any part of the MasterCat searches are the same for building a consumer profile for anticipated searches or doing a keyword search for a specific used product.

All consumer to consumer products are associated with a designated bar code in the MasterCat. This allows for simple confirmation of receipt and payment by the seller and purchaser. In the alternative no bar code is used and products are merely paid through the security already provided by the origin encryption. The same process exists as in other parts of the catalogue for offers, counteroffers, and acceptances.

Kioks are computer display terminals. They are typically found in large malls, chain stores, tourist locations or anywhere where shopping, and entertainment is important. They can be artistic branding displays serving the trademark needs of the locality or store. They can be in a local cafe or bookstore. They serve more than simple advertising displays. They are are also data centers geared to the specific Origin Nation cardholder.

The kiosk is a high-speed Internet connection and potentially linked to an Automated Teller Machine. It is touch screen and can include a typewriter keyboard for more complex search functions.

The kiosk will have all the store specific discounts for the origin code who enters their origin code. Activation of the profile should be by direct, secure link to the “Origin Nation,” computer processing center. In this way the actual origin code of the individual would remain unknown to the local store but still allow access to the kiosk.

As one incentive to get customers to make an in store visit the in store display may only have discounts that can be accessed with an actual in store visit. This will also differentiate discounts to locals and provide added incentive to have the costs associated with the kiosks.

The kiosks are linked to an electronic hand held wallet. This is in reality a personal computer wallet. This personal computer wallet contains all the important information of the consumer profile, which is contained in the Internet MasterCat. It has a large liquid crystal display for surfing the Internet. It can also function as a cell phone and has the added feature of a small keyboard or more simply be operated by touch screen display.

It has a universal serial bus for downloading data from the MasterCat that is specific to the individual consumer data cardholder's profile. It can also be connected to the Internet, for the same purpose, via a low or high-speed telephone Internet connection. With the added feature of a high data capacity personal computer wallet, which functions as a miniature hand held hard-drive. The wallet can take the form of a fashion accessory but its primary importance is to function wallet sized—able to fit into one's pocket.

The wallet contains the consumer data cardholder's profile and catalogue. In an abbreviated slimmer form it may simply function as a far more advanced smart card, able to be connected to a universal serial bus or Internet connection on one's home computer for downloading data related to the MasterCat and their consumer profile. In this means it would be a card able to fit into one's wallet. Moreover if the serial bus were far more smaller it would make the card slimmer or the card may simply function like a more advanced smart card that has a similar data capacity to a flash drive, and be able to be carried on a key chain. If functioning as a smart card then the card would function more to allow access to the Origin Nation central data processing center than be programmable itself.

The personal computer wallet would be one, which is helpful to the consumer in more ways than simply displaying their discounts directly or as they surf the Internet or view their information on a remote kiosk. It would provide information on shopping lists and sort their associated discounts of things on sale where they regularly shop: like a personalized circular.

The personal computer wallet could have the added feature of functioning as a cell phone or contain downloaded music. It may be connected wirelessly to the Internet or have receivers for satellite radio or have saved downloadable music. It may be connected wirelessly to remote activation devices and unlock your doors or shut of your lights or start and warm up your car on a very cold morning.

The personal computer wallet linked to the consumer data card would allow the consumer to maintain control over their individualized profile, giving them an important sense of control over their data. Through the wallet, as previously described, they can control solicitations and wipe their profile in whole or in part.

And the wallet has theft guard features, which allow for remote deactivation or activation of a remote self-contained alarm or locator. Interestingly these features may be very important for the elderly who are home bound or hikers who are lost.

The wallet contains a bar code reader and product tag deactivation scanner: allowing one to deactivate an in store product tag allowing for product search and buy without ever having to speak to a store worker to find the product or go through check out in the following manner:

Enter the store and activate your wireless pin code on the wallet. Go over to the kiosk and request the location of a specific product. The kiosk will walk you to the product location in the virtual store online. The consumer data cardholder then walks to the product location deactivating the product by scanning the bar code or deactivating the product tag with the personal computer wallet. Having set their pin they can now exit the store as their transaction has already been registered. Store security can view a simple proof-of-purchase receipt on the hand held computer of products purchased. If the customer wants a hard copy they can merely print it would late.

Perhaps the most exciting aspect of the remote kiosk is the ability to shop remotely! The kiosks are connected to the Internet. You can click on any kiosk in any store location in the world and be walked down the isle to the product as if walking through a virtual store and buy that product for shipment to your home. You can get advanced shopping and travel information from the kiosk—instantly—weather, travel information of airlines, traffic, hotels, and much more, and all in your own language.

I claim:

1. A consumer data credit card or debit card making use of consumer data—for use on the Internet, and linked to a master catalogue of products comprising the steps of:
A. data mining of the consumer cardholder's profile for past purchases and surveying their anticipated purchases through in person interview, and telephone questionnaire and Internet online questionnaire;
B. data storage of the consumer profile for analysis, use and transmission over the Internet;
C. encryption of the consumer identity also known as their “Origin Code,” allowing the circulation of their consumer profile data without out their identity being revealed;
D. online tutorial or orientation for the cardholder on how to use the master catalogue of products, goods, and services, and how to regularly refresh their consumer data profile as one means of controlling solicitations;
E. dispersals of identity encrypted consumer data profiles to retailers on the Internet to establish discount offers;
F. processing acceptances and associated billing.

2. Claim 2 achieving a universal discount of the dedicated customer approved at stores, where the consumer regularly shops, comprising the steps of:
A. obtaining a universal discount by virtue of a simple dispersal of data via the Internet or telephone land line containing the origin code's predetermined consumer profile as a target market for anticipated purchases at the product supplier store or Internet point of sale;
B. establishing a periodic unit of time threshold for an in store visit or product purchase or web site visit to meet the minimum eligibility standards to be considered a dedicated customer;
C. tracking past and present purchasing data of the consumer cardholder for recorded purchases that meet minimum standards;
D. regular dispersals of consumer data to the retailer confirming in store visits;
E. consumer's buying habits and purchasing power is linked to other data cardholders for added leverage in brokering a universal discount of their savings to the product supplier linked to the Internet;
F. competitive price comparison section in the Internet master catalogue between local merchants displaying their competing shopping information including per product price or comparison universal discount;
G. the consumer is given specific email or regular mail directives on purchases to maximize their leveraging power;
H. continued dispersals of consumer data in an attempt to broker discounts for specific products or overall discount by steering customer business to proper store.

3. Claim 3 comprising the establishment over the Internet of a universal master catalogue of manufacturers, goods, products, and services also known generically as: product suppliers, and linking the consumer data credit card or debit card and comprising the steps of:
A. product and service offer advertisements are posted on Internet coming in from product suppliers consisting of discounted and non-discounted products and going into the “General Section” of the catalogue;
B. product and service offer advertisements are posted on Internet coming in from product suppliers and some qualifying to go into the “Best Buys” section of the catalogue;
C. product and service offer advertisements are posted on Internet coming in from product suppliers, then going into the “Hot Brands” section of the catalogue;
D. consumer data cardholder's origin web address (home page of the master catalogue) has an option for encryption of their web or Internet service provider's address or home address and Internet cookies remain unknown, as they search the catalogue;
E. consumer data cardholder can option to leave the Internet cookies to us: to track and disperse their data of visits through the entire Internet catalogue or general Internet visits outside the catalogue to product suppliers;
F. consumer data cardholder can option to allow the advertisers to view their Internet cookies while visiting the catalogue allowing them to receive discount offers based on their recent views;
G. consumer data cardholder searches the catalogue updating their profile by clicking through on product icon to demonstrate product interest for potential price reduction offer from product supplier linked to the Internet or;
H. consumer data cardholder can limit the amount of solicitations that come through in regulating pop up ads and regular web solicitations for specific types of products and thus enhance their focus for the things that they really desire and anticipate purchasing;
I. in the alternative partial or all control blocking of internet ads can be taken away from the consumer
J. requests for solicitations from product suppliers in the Internet catalogue can be by accomplished clicking on category of products or by clicking on brand or by clicking on store or by clicking on geographic region for all stores or selected stores in the geographic region;
K. consumer can request a product search by key word search and request a discount for the product by simply clicking on the product or simply enter and price offer for the product;
L. in the alternative consumer can request its offer be bulked with other consumer requests into a consumer pool for leveraged discounts;
M. consumer can request an advisory on any product for pooling or price discount information from the consumer data center;
N. consumer can be instructed by the data processing center to make a hidden pool of group data, to be held in abeyance, for a specific product, for a group offer to the product supplier;
O. consumer can follow recommendation for price discount offer based on posting a general figure through their origin master catalogue or in conjunction with total numbers of consumer data cardholders requesting a discount;
P. all consumer's offer data can be hidden from the product supplier for brokering in later dispersals from an open pool;
Q. in the alternative all consumer data can appear notoriously in an open pool posted in the master catalogue or revealing consumer data in streaming data dispersals directly to the individual merchant;
R. consumer data that is brokered is leveraged in a carrot and stick—by stages approach—achieving greater and greater discounts for the entire pool in the final strike price;
S. in the alternative product supplier linked to the Internet can set incentive pool discount(s) basing prices on total offers openly received;
T. in the alternative product supplier using the carrot and stick approach to the consumers can offer product and accept offers, in stages—higher priced discounts—as more people come into the pool—as an incentive to get more people to make a firm offer on the product with time limit on the pool;
U. in the alternative the product supplier can run real time offers in and run real time rejections and acceptances;
V. in the pool a consumer can request an option to purchase the product at a specific price for an option fee;
W. in the alternative without a fee: a rain-check can be issued which is (transferable or non-transferable), the rain check expiring at a specific period of time;
X. in the alternative consumer can take on line coupons of existing discounts and pre set redemption for actual point of purchase without having to print our the coupon;
Y. in the alternative consumer profile can be automatically linked to all discount coupons offered by the store, without a need for offering the coupon for redemption, but merely having to purchase the product as it is part of their discount profile.
Z. all sales transactions are processed, true data cardholder's number is revealed or check payments routed electronically;
AA. associated overall statistics of the bulk sale is charted and posted on the Internet to educate the consumer on future offers;
BB. continuing data storage, mining, and analysis which updates the consumer profile to continue the above mentioned cycle for new products, goods or services.

4. Claim 4, is dependent on claim 1 or 2 or 3 and concerns the pooling of consumer offers in the “Best Buys” and “Hot Brands” catalogue sections for discounts and comprising the following steps:
A. consumer data cardholder is given guidance about the product in rating or descriptive form, and time limit of an open pool for offers on the product;
B. consumer data cardholder decides to make a firm discount offer: (hot lead), for the product at the recommended data center discount price or at any discount price;
C. consumer offer data is held in abeyance, for leveraged dispersals to product supplier to achieve the maximum discount;
D. in the alternative consumer data goes directly to the product supplier;
E. product supplier can make a counteroffer or acceptance;
F. product supplier can set levels of the discount based on a singular overall discount or in a carrot and stick approach, at an increase level of savings depending upon the total numbers of people who continue to participate in the pool;
G. consumer data cardholder decides to flag an undecided (warm lead), interest in the product at their possible purchase price;
H. product supplier can make various counteroffer incentives related or unrelated to price (if unrelated to price then something of value);
I. consumer data cardholder can pay a fee to secure an option to lock in a final offer—final strike sales price of the pool;
J. in the alternative option can be at a different cost for a different price for example, a lower or higher price: the lower the price the more expensive the option;
K. in the alternative retailer can reject an option;
L. in the alternative retailer has to accept all options;
M. all consumer data cardholder offers hot, and warm leads, and options to buy are bulked, and analyzed, by the consumer data center to broker the leads to the product supplier for leveraging to lower the price;
N. leads are sent to the manufacturer in a series of bulk dispersals or flowing real time streams to maximize the lowest price in a carrot and stick approach;
O. manufacturer may be permitted the opportunity to post a counter offer to the group or directly to the individual leads, which is set to expire at a specified time;
P. manufacturer acceptance or counter-proposed price at its various levels is posted on the Internet in the master catalogue;
Q. a second or more round of steps A-P takes place, until the final strike price is locked in when—all consumer data cardholders benefit equally;
R. all consumer data card holders do not benefit equally if there is a fast pool with limited product supply then the final strike price is as offers are individually accepted;
S. option holders do not benefit equally, but must opt to pay the option price, unless they bought a strike price option;
T. all sales transactions are processed, true data cardholder's number is revealed or check payments routed electronically;
U. associated overall statistics of the bulk sale is charted and posted on the Internet to educate the consumer on future offers;
V. continuing data storage, mining, and analysis, which updates the consumer profile to continue the above mentioned cycle for new products, goods or services.

5. Claim 5, is dependent upon claim 1 or 2 or 3 or 4, and concerns the “My Discounts,” section of the master catalogue and comprising the steps of:
A. the origin encrypted consumer data profile of the cardholder is dispersed to product suppliers.
B. product suppliers come back with discount offers to the specific origin code, which are sorted into this section of the catalogue.
C. this catalogue has all the features of all other parts of the catalogues, for pooling, offers, counter offers, and options.

6. Claim 6, is dependent upon claim 1 or 2 or 3 or 4, or 5, and concerns the “Consumer to Consumer” discount section for used goods and comprising the steps of:
A. consumer can request specific types of used goods in their consumer data profile; including a hierarchy of the most important search information the consumer desires including: product or brand and price willing to pay;
B. offers are automatically routed of those used products presently being offered for sale; with product and price information from the consumer who posted the ad;
C. product has a bar code associated with it, and posted for printing on the computer;
D. offers are sorted for the consumer, in a prearranged search and a series of the products are displayed with the closest match of type, location and price at the top of the origin code's list, and the lowest match at the bottom;
E. offers regularly come in, and are updated without the consumer having to request the updates or new searches;
F. the buy sell transaction is automatically processed through the secure encrypted codes with immediate payment or deduction to the cardholder;
G. both consumers can click on barcode icon creating an agreement to ship for satisfaction and acceptance of the product before payment;
H. barcode is printed and product is shipped with the barcode;
I. consumer purchaser likes product and has the barcode scanned at any product supplier who accepts the consumer data credit card;
J. the transaction is processed with one card charged and one credited;
K. in the alternative, the consumer returns the product at shipping location that independently inspects and ships back to the consumer who sent the requested product, while barcode is scanned confirming proper shipment.
L. in the alternative consumer ships back to the consumer rejected product noting dissatisfaction to data processing center;
M. in the alternative all potential payments are held in escrow with prepaid shipping insurance agreement for lost, stolen or damaged goods.
N. all shipping methods are by pre-agreement between cardholders and Payments and deductions are processed through the methods described by the computer data center;
O. in the alternative all offers and acceptances are simply processed through the security afforded by the origin code encryption.

6. Claim 6, is dependent on claim 1 or 2 or 3 or 4 or 5, and concerns the pooling of consumer offers in the “Competitive Products” catalogue sections (conducive to any product offered in competition including, insurance or health maintenance organizations or interest loan rate and comprising the following steps:
A. consumer data cardholder is given descriptive information about the competing products side by side, and time limit of an open pool for offers on the products;
B. consumer can update their profile to the specifications of the competitive pool and offers can come through to the consumers directly and individually;
C. in the alternative each consumer can update their profile to the specifications of the competitive pool, and offers can come through to the consumer pool as a group, and be subsequently posted notoriously on the Internet with a subsequent confirmation of the consumer's eligibility sent to each individual separately;
D. all offers from product suppliers to all parties remain open for all product suppliers and consumers to view;
E. in the alternative product suppliers do not know the competitive pricing of their competitors only the consumer and data processing center does;
F. consumer can make offers to one or multiple product suppliers at the same time, and need only accept one acceptance within a specified time;
G. in the alternative consumer can only make firm offer to one product supplier who must reject within a specified time;
H. in the alternative all offers are held in abeyance for dispersals and leveraging by the consumer data center;
O. in the alternative consumer data cardholder decides to make a firm discount offer (hot lead), for the product at the recommended data center discount price or at any discount price directly to the product supplier;
J. product supplier can make a counteroffer or acceptance;
K. in the alternative product supplier can set levels of the discount based on a singular overall discount of total offers received or in a carrot and stick approach for shoppers by exhibited increased levels of savings depending upon the total numbers of people who participate with firm offers—all offerors share equally in the strike price—regardless of their prior offer under this method;
L. in the alternative offerors do not share equally but their acceptances are based on their original offer if within range of the strike price;
M. consumer data cardholder decides to flag an undecided (warm lead) interest in the product at their possible purchase price;
N. product supplier can make various counteroffer incentives related or unrelated to price but something of value;
O. consumer data cardholder can pay a fee to secure an option to lock in a final offer final strike sales price;
P. in the alternative option can be at a different cost for a different price for example, a lower or higher price: the lower the price the more expensive the option;
Q. in the alternative retailer can reject an option;
R. in the alternative retailer has to accept all options;
S. in the alternative all consumer data cardholder offers hot, and warm leads and options to buy which are bulked and analyzed, to broker the leads, to the product supplier and are leveraged to lower the price;
T. leads are sent to the product supplier in a series of bulk dispersals or data streams to maximize the lowest price in a carrot and stick approach;
U. product supplier may be permitted the opportunity to post a counter offer to the group or directly to the individual leads which is set to expire at a specified time;
V. product supplier acceptance or counter-proposed price at its various levels is posted on the Internet in the master catalogue;
W. in the alternative acceptances are by individual email notifications or posted in the origin master catalogue of each origin code.
X. a second or more round of steps A.-W take place, until the final strike price is for all consumers is locked in;
Y. option holders do not benefit equally, but must opt to pay the option price, unless they bought a strike price option;
Z. all sales transactions are processed and true data cardholder's number is revealed or check payments routed electronically;
AA. associated overall statistics of the bulk sale are charted and posted on the Internet to educate the consumer on future offers;
BB. continuing data storage, mining, and analysis which updates the consumer profile to continue the above mentioned cycle for new products, goods, or services;

7. Claim 7, dependent upon claim 1 or 2 or 3 or 4 or 5 or 6, linking the credit card to a battery operated personal computer wallet; consumer profile credit data is downloaded into an electronic personal computer wallet having its data switching functions operated by computer chip(s); in the alternative the electronic personal computer wallet can have an alternate high capacity operational functioning as an external hard drive; the electronic computer wallet is connectable to the universal serial bus on a home computer, the Internet or high speed internet access or regular internet telephone land line or wireless network.

8. Claim 8, dependent on claims 1 or 2 or 3 or 4 or 5 or 6 or 7, linking select data transactions to remote computer kiosks with display screen and linking to the Internet master catalogue and containing site store information or general regional information with accessibility to origin code users specified data, through central data processing, allowing the transacting of sales at the kiosk or having automated teller machine capability and comprising the steps of:
A. recognizing the encrypted origin code or the magnetic strip credit card or smart card or personal external computer wallet via a universal serial bus or telephone land line or regular or high speed Internet connection or local wireless network connection;
B. calling up the origin code data of the catalogue as specific cardholder data for the specific catalogue or store requesting data central processing in a manner that conceals the actual origin code and maintains privacy of the consumer data profile;
C. the customer requesting a specific product by touch screen search or computer typewriter keyboard data entry at the kiosk;
D. the kiosk exhibiting product information on the screen;
E. the video kiosk walking the shopper through a virtual store or mall to an exact product location or store;
F. cardholder activating the electronic wallet by a pin code activator for in store purchases;
G. allowing personal recording of in-store transactions through an electronic product tag reader or bar code reader contained within the personal computer wallet.
H. deactivating the product tag permitting, at the store exit, with deactivated products purchased, and not having to go through a cash register check out line;
I. displaying a date and time paid function by LCD screen receipt, of products bought, permitting exiting the store through on site security;
J. allow you to virtual shop or explore a geographic region—at home or though the wallet—for travel and shopping information by linking data in the kiosk to the Internet;
K. in the alternative, displaying only some consumer data cardholder discounts; displaying other discounts, for the consumer who makes an actual in-person, in-store visit, as an incentive to get them to shop there.

9. Claim 9, dependent on claims 1 or 2 or 3 or 4 or 5 or 6, or 7 or 8, with the personal computer wallet having additional computer functions linking the personal consumer data profile with the combined features of:
A. all available computer data that would be in the Internet master catalogue could also be, in whole or in part, on the personal computer wallet;
B. all control functions in the Internet master catalogue could be displayed and controlled in the electronic wallet, as on the Internet master catalogue;
C. all profile data for anticipated purchases can be regulated by the consumer or the central data processing center and brokering of the data dispersals of the consumer;
D. display a discount product shopping list of the consumer's products usually bought or products that are offered for a discount per the origin code data profile per the store shopped;
E. display general or dramatic advertising circular information to the regular public including in store redeemable coupons or discounts that can be redeemed through the electronic wallet at time of purchase.

10. Claim 10, dependent on claims 1 or 2 or 3 or 4 or 5 or 6 or 7 or 8 or 9, with the wallet having various combined computer functions linked to the consumer data profile; the features of allowing the consumer to wipe clean their profile data in part or in whole, to stop or regulate solicitations or for reasons of privacy or to end service.

11. Claim 11, dependent upon claims 1 or 2 or 3 or 4 or 5 or 6 or 7 or 8 or 9 or 10, the wallet containing a remote wireless radio broadcast beacon remote locating device, and audible alarm, and deactivation switch—all of which can be activated by remote telephone signal code dialed into the wallet.

12. Claim number 12, dependent upon claims 1 or 2 or 3 or 4 or 5 or 6 or 7 or 8 or 9 or 10 or 11, allowing the product supplier to directly fix the percentage of discounted price posted in the Internet Master Catalogue, before offers are realized or basing the posted discount in the Interet Master Catalogue on the merchant or product supplier's (again a broad generic term for merchants, retailers, manufacturers, producers, service's), offers they receive from consumers or businesses and comprising the steps of:
A.) Pre-posting the numbers of confirmed offers, at specific prices that would generate a specific price discount, at those stated pre-specified level(s), of incoming confirmed offers received, through the Internet Master Catalogue or email collection sorting system for the product (this sorting is based primarily on the price range of incoming offers).
B.) Using a carrot and stick approach to bring in more consumers into the pool, for the specific product, by dropping the price lower and lower, as more and more people make confirmed offers, until lower and lower price discount levels are achieved, allowing a single discounted strike price for the entire pool.
C.) Alternatively establishing a time frame for the discount offer, based on posting the current number of available units remaining and those sold, then basing pricing based on numbers of units remaining.
D.) Posting in the Master Catalogue a time limit for the pool.
E.) In the alternative fixing a single notorious discounted price that would be realized for the pool, when a pre-specified number of confirmed offers, posted as a continuously updated tally in the Master Catalogue, have been received. This tally may include estimated time for pool approval based on running totals.
F.) If the discount is not achieved by the preestablished pool levels, then product supplier can make a counter offer to the entire pool, as individuals or as a group.
G.)Setting prices for options of the consumer to purchase a specified discounted product in the initial stages of offers or some time in the future, at a pre-specified price or issuing a rain check for the product, at some specified discounted price, after all offers are accepted.
H.) In the alternative allowing the product supplier to receive confirmed offers for products through the Internet Master Catalogue, for products not yet assembled or manufactured or produced, and so pass onto the consumer a planned discount, based on, cost projections, supply, and funding.
I.) Allowing the consumer to communicate directly with the product supplier, through the Internet Master Catalogue via email or other electronic means of communication, making a firm offer for a specified, not yet, manufactured product(s) or product(s) produced, individually or within an open pool, of consumers, as listed in the Internet Master Catalogue, specifying the future date the product will be manufactured or produced and delivered.
J.) Product supplier can make all offers notorious, through the Master Catalogue, as an incentive to lead others to make offers and seeking to build a strike price for the pool.
K.) Product supplier can leave all offers received opaque to the public, and so make their own decisions on various price levels and recommended discount offers to the pool, for the product.
L.) Product supplier must stay within the pre-specified confirmed acceptance guidelines for the pool, related to the price, of the not yet manufactured product, unless they choose to advantage their offer, with a lower price structure, to achieve a larger pool of consumers; with the main goal of achieving a strike price for the entire consumer pool.
M.) In the alternative all pool members do not take equally but according to a floating price offer and acceptance guideline established in-house by the product supplier.
N.) Product supplier can offer options at a price or rain checks to purchase in the future, set to expire at a specific time.
O.) In the alternative allowing the product supplier to directly fix the percentage of discount in the Master Catalogue, based on special seasonal promotional(s), such as year end sales, September back to school sales or inventory overstocking or liquidation sales or Holiday sales, by establishing guidelines for sales through the Internet Master Catalogue based on overall promotional sales attraction, exampled by, confirmed Catalogue page views and confirmed offers received through the catalogue promotional.
P.) Then fixing percentage of discounts, based on a threshold(s) of orders: the more orders the lower the discount for the group.
Q.) Allowing early arrivals to buy preferred options, to buy the product that potentially consists of a higher or same pool strike price option to purchase, set to expire by a specified time.
R.) In the alternative product supplier can float their offers and acceptances according to in-house guidelines.
S.) In the alternative allowing a central data processing center to accomplish the previous steps A to R or aid in the offer acceptance process.
T.) In the alternative the entire system of actual purchases by passes—a critical step in the Master Catalogue—of actual acceptances of consumer offers—and discounts are realized at point of sale merchant for all subsequent consumer data credit or debit card holders, for a specified or reasonable time (this important condition holding true for all previous and forward dependent claims).

13. Claim number 14, dependent upon claims 1 or 2 or 3 or 4 or 5, or 6, or 7 or 8 or 9 or 10 or 11 or 12, allowing the Consumer to fund a specific brand for multiple purchases, such as, but not limited to, food items or drugs. Thus establishing brand loyalty or generic product merchant loyalty, and a pre-set discount depending upon the number of pre-set purchases the consumer pays for and comprising the steps of:
A.) Displaying those items posted allowing confirming purchases in the future in the Internet Master Catalogue or in store circular.
B.) In the alternative allowing the consumer to pre-select the products and numbers of confirmed orders they would like to place at a discount offer they specify.
C.) In the alternative the consumer follows guidance from the product supplier or central data processing facility on making future purchase discount offers.
D.) In the alternative pre-paying for whole groups or lines within product categories, of products, and obtaining a discount based on the offer(s) individually, as specified for the group.
E.) In the alternative product supplier can float their offers and acceptances according to in-house guidelines.
F.) Displaying a time limit for pick up of the product(s) or displaying shelf availability and numbers of units that can be picked up within specified time frames of items bought or available for pre-purchase.
G.) Displaying within the Master Catalogue or store circular a per unit discount based on a gradient of lower prices, based on the number of units pre-bought.
H.) Transacting and maintaining a record of the consumer's purchases, by the product supplier or central data processing facility.
I.) Recording feedback to the consumer, allowing them to restock or replenish their pre-bought stock before supplies run out.
J.) In the alternative the entire system of actual acceptances set up through the Internet Master Catalogue of offers by passes the Internet Master Catalogue, and discounts are realized at point of sale merchant by paying on site, requiring only membership in the consumer data credit or debit card.
K.) In the alternative the entire data processing system is automatic, requiring no product supplier to make offers, but rather the Master Catalogue and central data processing system automatically cycles through product categories with public offers, previously described, and all data dispersals are automatically pre-set; based on the preprogrammed steps, previously described, of offers and acceptances, and as time proceeds, an historical analysis maximizes discount potential based on past transactions between consumers and product suppliers, their competition for offers, product availability, projected demand, and more generalized, future economic indicators.
Claim number 14, dependent upon claims 1 or 2 or 3 or 4 or 5, or 6, or 7 or 8 or 9 or 10 or 11 or 12 or 13, allowing consumer to build their own autonomous consumer to consumer alliances, against product suppliers, within the Internet Master Catalogue, as teams, within product categories and consisting of the following steps:
A.) Posting invitations to attract team members for consumer pools.
B.) In early team formation selecting one trusted team leader acting as gatekeeper along with possible subordinates who also act as gatekeepers, for information bridges and data dispersals on pre designated targets.
C.) Team leader takes, examines, pool feedback, via email or secure catalogue posting and communicates to members via private email or public or secure (need to know), posting within the Master Catalogue.
D.) In the alternative product supplier or central data processing facility similarly communicates with team leader and pool; aiding and advising to accomplish maximize discount.
E.) Team leader disperses requests of incoming data on offers from product suppliers for various products within a category pre-sorted according to price level(s) offers with the designed purpose to achieve discounts for the consumers or simply for brand names or generic products acceptances or counter offers for discounts from product suppliers. It should be noted: this can be an automated step process, with data dispersals by the team leader directly to the central data processing system or as pre set via an automatic programmed function within the Internet Master Catalogue requiring no team leader action.
F.) Team leader has incoming data on offers from product suppliers or recommendations, for pool price offers, and projected parameters or potential discounts, from the central data processing center.
G.) Team leader formulates his own relevant voting question(s), for pool consumers or takes voting suggestion from product supplier or data processing center; these votes are in ballot form allowing for pre-sorting relevant data (primarily on offers), into usable categories for later data dispersals to product suppliers or consumers.
H.) Consumer vote's takes place in a series of rounds that are automatically sorted, for confirmed targeted dispersals: votes embody specific questions related to price, product, and offer.
I.) Gatekeeper sends timed warning of: “Time for final offers,” readying data dispersals of team members (Timed warning can be through any electronic communicative devices).
J.) Gatekeeper releases offers upon targets.
K.) System registers any counteroffers, and cycles offers and acceptances directly to consumers, and product suppliers, which can recycle, until there is a strike price for the pool(s).
L.) In counter offer stage or pre-acceptance stage, a team leader (and for all claims described in all specifications herein, the central data processing facility), can regroup the pool(s), before acceptances, in whole or part, for a stand off on price, against product supplier, and notoriously open up the pool to other product suppliers who can counter offer to any open pool and capture the pool in whole or in part with an approved consumer pool acceptance in whole or part.
M.) In the alternative offers and acceptances are accepted individually, within groups, based on free floating in-house guidelines of the product supplier.
N.) In the alternative the entire system of actual purchases—by passes—this critical acceptance step in the Master Catalogue: (it should be noted, more specifically, for all related claims, that all interrelated claims of the Internet Master Catalogue may also include the use of published catalogue material), of actual acceptances of offers, and discounts are realized at point of sale merchant acceptance, regardless of actual membership in the Master Catalogue, but only membership in the consumer data credit or debit card, for a specified or reasonable time.
O.) In the alternative the entire data processing system is automatic, requiring no team leader, but rather automatically cycles through product categories with public solicitations to gather team members, and all data dispersals on offers and acceptances are automatically pre-set; based on the preprogrammed steps just described, through the central data processing facility, and as time proceeds, an historical analysis maximizes discount potential, based on past transactions between consumers and merchants, and consequential future projections, as accomplished primarily through the central data processing system.
P.) More specifically, in the alternative, no Master Catalogue is required for all previously stated claims, and central data processing system accomplishes methodologies, for all transactions by (consumer data credit or debit card holding members), by having consumers create a shopping list of the things they will buy or automatically creating them a shopping list based on past purchases, confirmed anticipated purchases, or data mining, and segregating that money for their future purchases; all discounts are registered automatically at point of sale merchant, as achieved by the central data processing system acting as liaison to products suppliers, responding to either pre-programmed percentile standards and or the standards set by the interrelated claims in all specifications of my claims.
Q.) A preset notification system for rounds; sending an email or Internet Catalogue Alert or by other electronic means, which creates an alert signal, when an offer is accepted or has been countered or a new pool is opened or about to close or is declared, “open to potential capture” or automatically presented for potential capture (as part of this business methodology), by another product supplier and a subsequent offer has come in from that product supplier, to capture the pool with a better counter offer.
R.) More specifically, to characterize all previous interrelated claims, the business system methodology can be accessed without a consumer data credit or credit card but by oral agreement at point of sale or prior written agreement or alternative and approved store specific card or generic (cash or discount card), allowing product supplier access or as part of a planned in store promotional to benefit all consumers and need not require membership in the card—at all—but can be a benefit realized by this entire business methodology, when paying at point of sale or pre-paying for purchases in cash, or tangible or intangible or commercial paper or promissory note.
S.) More specifically, the Internet Master Catalogue or personal computer wallet containing the consumer data card or debit card (an interrelated claim throughout all claim specifications), may benefit the consumer or product supplier by displaying monetary exchange rates, which are gains realized by the consumer.
T.) In the alternative this gains are captured as monetary conversions with associated fees as provided through the central data processing facility.
U.) As a promotional methodology the entire system method described through the Internet Master Catalogue may take the form—via a live or programmed television cable broadcast—for pay or public access also available on the personal computer wallet or cell phone or mobile personal computer or in store promotional display or kiosk linked to the consumer debit or credit card or cash payment functionality or check out or self check out or by virtual shopping previously described in the related claims(s).
